(19) United States
(12) Patent Application Publication
(10) Pub. No.: US 2011/0225973 A1
(43) Pub. Date: Sep. 22, 2011

(54) Combustor with Pre-Mixing Primary Fuel-Nozzle Assembly

(75) Inventors: Bryan Wesley Romig, Simpsonville, SC (US); Derrick Walter Simons, Greenville, SC (US); Lucas John Stoia, Taylors, SC (US); Karthik Subramanian, Greenville, SC (US)

(73) Assignee: General Electric Company, Schenectady, NY (US)

(21) Appl. No.: 12/726,704

(22) Filed: Mar. 18, 2010

(51) Int. Cl. F02C 7/22; F02C 3/14

(52) U.S. Cl. 60/737; 60/748; 60/752

(57) ABSTRACT

A combustor includes a first combustion chamber, a pre-mixing primary fuel-nozzle assembly associated with the first combustion chamber, a second combustion chamber, and a secondary fuel-nozzle assembly associated with the second combustion chamber. The pre-mixing primary fuel-nozzle assembly includes a number of vanes configured to swirl airflow, each vane comprising a number of fuel injection holes configured to inject fuel into the airflow.

### TECHNICAL FIELD

The present application generally relates to a combustor for a gas turbine, and more particularly relates to a two-stage low NOx combustor with a pre-mixing primary fuel-nozzle assembly.

### BACKGROUND OF THE INVENTION

Low NOx combustors for gas turbines are known in the industry. For example, U.S. Pat. No. 4,292,801 describes a “Dual Stage-Dual Mode Low NOx Combustor” that creates reduced amounts of nitrogen oxide (NOx) during the combustion process. FIG. 1 is a cross-sectional view of an embodiment of such a known combustor 100. The combustor 100 generally includes a first combustion chamber 102 and a second combustion chamber 104. The combustion chambers 102, 104 are defined on an outer perimeter by a combustion liner 106 and are separated by a throat of reduced cross-section, which acts as a thermodynamic separator to segregate the two combustion zones.

On an upstream end, the combustor 100 is enclosed by an end cover 108. The end cover 108 supports a number of fuel nozzles that can communicate fuel into the chambers. More specifically, a number of primary fuel nozzles 110 provide fuel to the first chamber 102 and a secondary fuel nozzle 112 provides fuel to the second chamber 104. The primary fuel nozzles 110 are usually positioned in a circular array about the secondary fuel nozzle 112, which is centrally positioned and extends axially through the first chamber 102 toward the second chamber 104.

So that air can enter the combustion chambers 102, 104, a flow sleeve 114 is positioned about the combustion liner 106. The flow sleeve 114 and combustion liner 106 together define an annular air passageway 116 that is in communication with the compressor. Air from the compressor flows through the annular passageway 116 and enters the combustion chambers 102, 104 through an annular gap 118 between the combustion liner 106 and the end cover 108.

In operation, fuel is selectively introduced through the primary and secondary fuel nozzles 110, 112 to initiate and terminate combustion in one or both of the combustion chambers 102, 104 in a manner that generates reduced NOx emissions. In particular, the combustor 100 can be operated in a diffusion mode or in a pre-mixing mode. In the diffusion mode, fuel is introduced through the primary fuel nozzles 110 and combustion occurs in the first chamber 102. In the pre-mixing mode, fuel is introduced through both the primary and secondary fuel nozzles 110, 112, but combustion occurs only in the second chamber 104. The first chamber 102 serves as a pre-mixing zone where air and fuel are pre-mixed to form an air-fuel mixture, and the second chamber 104 serves as the combustion chamber where the air-fuel mixture is burned to generate hot combustion products. It is well known that combusting an air-fuel mixture that has been pre-mixed generates relatively lower NOx emissions. Therefore, the combustor 100 is typically operated in pre-mixing mode during steady-state operation, while diffusion mode is used in transition to steady state or when reduced output is needed.

One matter with the combustor 100 is that the primary fuel nozzle 110 is not a true pre-mixing nozzle. Instead, the primary nozzle 110 is essentially a fuel peg surrounded at a distal end by a separate air swirler. The air swirler swirls air about the fuel peg just upstream of its distal end, which injects into the air stream. Thus, the primary fuel nozzle 110 is typically considered to be a diffusion nozzle.

Another matter with the combustor 100 is that only a portion of the air that enters the first chamber 102 passes through the annular gap 118 and enters the air swirler. The majority of the air that enters the first chamber 102 passes through mixing holes formed directly in the combustion liner 106. The result is that very little pre-mixing can occur at the nozzle level in diffusion mode, and less pre-mixing may occur in pre-mixing mode than what could occur with better first stage mixing.

One type of known pre-mixing nozzle is a swirling annular fuel nozzle or “swozzle,” which typically includes a number of vanes extending between an inner hub and an outer shroud. The vanes are circumferentially spaced apart and include fuel injection openings. The fuel injection openings receive fuel through fuel passages that extend radially outward from fuel entry openings in the inner hub. In operation, air traveling axially through the swozzle is swirled by the vanes and fuel traveling radially through the swozzle is injected into the swirling air flow. Such a nozzle improves mixing but is typically used in a single stage combustor.

### BRIEF DESCRIPTION OF THE INVENTION

A combustor includes a first combustion chamber, a pre-mixing primary fuel-nozzle assembly associated with the first combustion chamber, a second combustion chamber, and a secondary fuel-nozzle assembly associated with the second combustion chamber. The pre-mixing primary fuel-nozzle assembly includes a number of vanes configured to swirl airflow, each vane comprising a number of fuel injection holes configured to inject fuel into the airflow.

In another aspect of the invention, a pre-mixing primary fuel-nozzle assembly includes an inner annular collar, a number of vanes, and a plurality of fuel injection holes formed in each vane. The vanes extend radially outward from the inner annular collar. The inner annular collar also may include a number of air passage openings.

In yet another aspect of the invention, a combustor includes a first combustion chamber associated with a pre-mixing primary fuel-nozzle assembly and a second combustion chamber associated with a secondary fuel-nozzle assembly. The pre-mixing primary fuel-nozzle assembly is concentrically positioned about the secondary fuel-nozzle assembly.

Other systems, devices, methods, features, and advantages of the disclosed systems and methods will be apparent or will become apparent to one with skill in the art upon examination of the following figures and detailed description. All such additional systems, devices, methods, features, and advantages are intended to be included within the description and are intended to be protected by the accompanying claims.

### BRIEF DESCRIPTION OF THE DRAWINGS

The present disclosure may be better understood with reference to the following figures. Matching reference numerals designate corresponding parts throughout the figures, and components in the figures are not necessarily to scale.

FIG. 1 is a cross-sectional view of a prior art two-stage combustor.

FIG. 2 is a cross-sectional view of an embodiment of a two-stage combustor in accordance with the present invention.

FIG. 3 is a perspective view of a portion of the two-stage combustor shown in FIG. 2, illustrating an embodiment of a pre-mixing primary fuel-nozzle assembly associated with an end cover.

FIG. 4 is a cross-sectional view of an embodiment of a vane of the pre-mixing primary fuel-nozzle assembly shown in FIG. 3.

### DETAILED DESCRIPTION OF THE INVENTION

Described below are embodiments of two-stage combustor configured for increased primary zone pre-mixing. Also described are embodiments of a pre-mixing primary fuel-nozzle assembly.

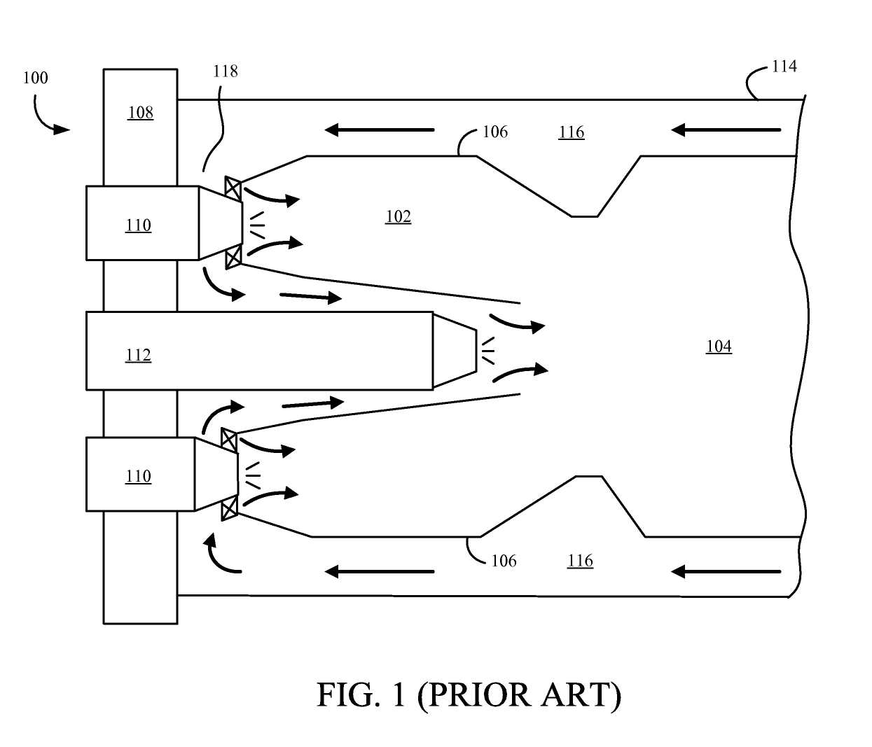

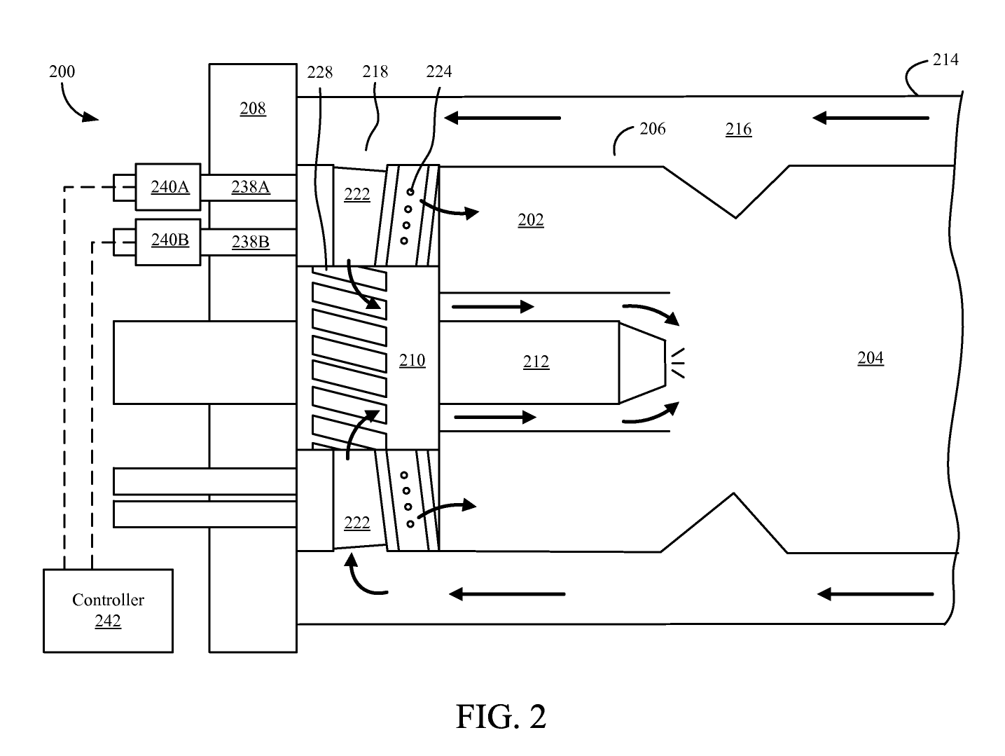

FIG. 2 is a cross-sectional view of an embodiment of a two-stage combustor 200. Like the two-stage combustor 100 shown in FIG. 1, the combustor 200 generally includes a first chamber 202, also referred to as the first stage or primary zone, and a second chamber 204, also referred to as the second stage or secondary zone. The first chamber 202 is located upstream of the second chamber 204. The combustion chambers 202, 204 are defined on an outer perimeter by a combustion liner 206 and are separated by a throat of reduced cross-section, which acts as a thermodynamic separator to segregate the two combustion zones. On an upstream end, the combustor 200 is enclosed by an end cover 208. The end cover 208 is spaced apart from the combustion liner 206, forming an annular gap 218. The annular gap 218 is in communication with an annular passageway 216 formed about the combustor 200 between the combustion liner 206 and a flow sleeve 214. Together the annular passageway 216 and the annular gap 218 permit air to reach the chambers 202, 204 from the compressor, driven by a pressure differential. In embodiments, the combustion liner 206 is substantially continuous or un-perforated so that substantially all of the air in the annular passageway 216 is directed through the annular gap 218 into the chambers 202, 204. In other words, the combustion liner 206 may lack mixing holes commonly found along the combustion liner about the first chamber.

Fuel can reach the chambers 202, 204 through fuel nozzles 210, 212. In particular, the combustor 200 includes a secondary fuel-nozzle assembly 212 that is supported by the end cover 208 and extends through the first chamber 202 toward the second chamber 204. The secondary fuel-nozzle assembly 212 may be an embodiment of a secondary fuel nozzle that is now known or is later developed. Because such fuel nozzles are known, further description is omitted here.

The combustor 200 also includes a pre-mixing primary fuel-nozzle assembly 210, which extends into the first chamber 202. The pre-mixing primary fuel-nozzle assembly 210 is supported by the end cover 208 on a rearward side and extends to the combustion liner 206 on a forward side. Thus, the pre-mixing primary fuel-nozzle assembly 210 may be positioned in the annular gap 218, substantially enclosing the annular gap, so that substantially all of the air entering the annular gap 218 from the annular passageway 216 flows through the pre-mixing primary fuel-nozzle assembly 210 before traveling into the combustion chambers 202, 204. Unlike the primary fuel nozzles 110 of FIG. 1, the combustor 200 includes only one pre-mixing primary fuel-nozzle assembly 210, which is annular in shape and is concentrically positioned about or encircles the secondary fuel-nozzle assembly 212. However, other configurations are possible. For example, more than one pre-mixing primary fuel-nozzle assembly 210 may be provided, and the pre-mixing primary fuel-nozzle assembly 210 may not be concentrically positioned about the secondary fuel-nozzle assembly 212.

The pre-mixing primary fuel-nozzle assembly 210 is configured for increased primary zone pre-mixing. In particular, the pre-mixing primary fuel-nozzle assembly 210 is generally a “swozzle” or air-swirling fuel nozzle that both swirls incoming air and injects fuel into the air to achieve a relatively uniform air-fuel mixture. Thus, the pre-mixing primary fuel-nozzle assembly 210 achieves improved pre-mixing in the primary zone, which reduces NOx emissions, and imparts swirl or circumferential velocity to the flow, improving flame stability downstream.

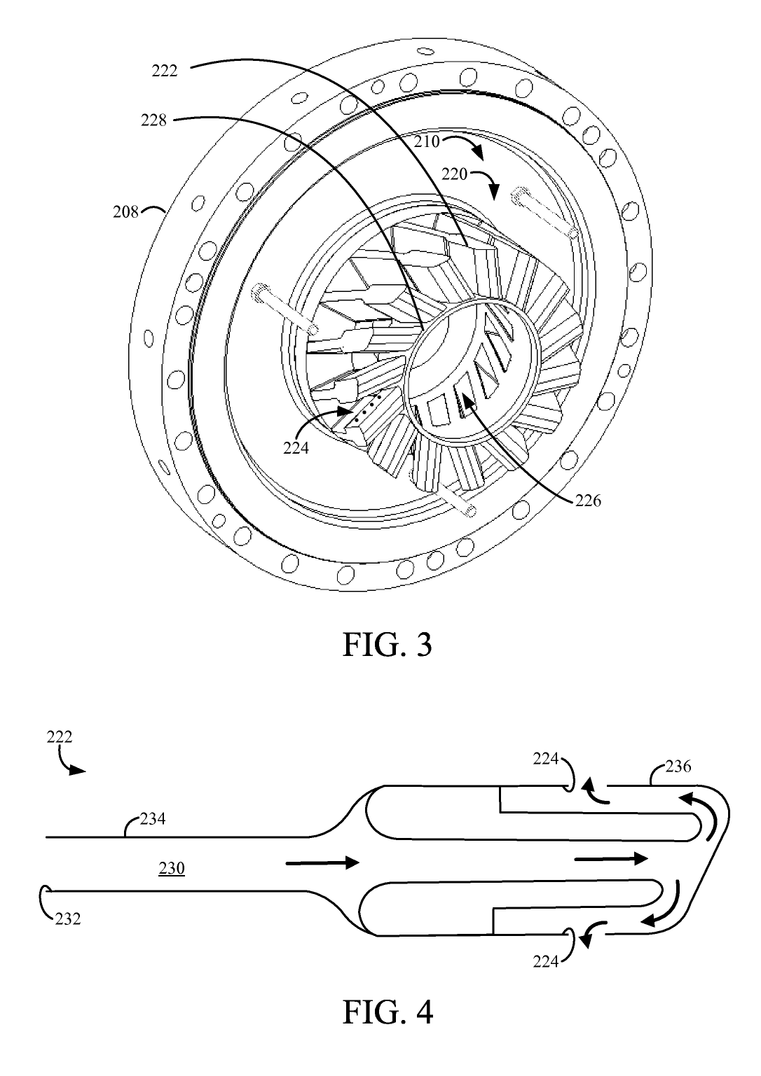

The pre-mixing primary fuel-nozzle assembly 210 is further described with reference to FIG. 3, which is a perspective view of the pre-mixing primary fuel-nozzle assembly 210 and the end cover 208 of the combustor 200 with the remainder of the combustor 200 removed. As shown, the pre-mixing primary fuel-nozzle assembly 210 includes an assembly body 220 that is generally annular in shape. The assembly body 220 includes a number of vanes 222 that are configured to swirl airflow, and each vane 222 includes a number of fuel injection holes 224 configured to inject fuel into the airflow. Each fuel injection hole 224 is in fluid communication with a fuel passage in the vane 222, which in turn is in fluid communication with a fuel manifold as further described below. The assembly body 220 further includes a number of air passage openings 226 that allow air to pass through the assembly body 220 into the secondary fuel-nozzle assembly 212.

In the illustrated embodiment, the assembly body 220 includes an inner annular hub 228 that supports the vanes 222, which are positioned about the hub 228 in an annular array, extending radially outward. The vanes 222 are spaced apart from each other and are open about an outer annular periphery. Between the vanes 222, the air passage openings 226 are formed through the hub 228. In other words, the vanes 222 and the openings 226 are circumferentially interleaved about the assembly 210.

Each vane 222 includes a fuel passage portion and an air foil portion. The fuel passage portion is positioned adjacent to the end cover 208 while the air foil portion extends away from the fuel passage portion in an axial direction. The fuel injection holes 224 are formed through the air foil portion, such as through one or both of a pressure side and a suction sides of the air foil portion.

FIG. 4 is cross-sectional view of an embodiment of one such vane 222. As shown, a fuel passageway 230 extends from a fuel entry opening 232 through the fuel passage portion 234 to the air foil portion 236, terminating at the fuel injection holes 224. In some embodiments, the vanes 222 are configured to be cooled by the flow of fuel through the fuel passageway 230. More particularly, the fuel passageway 230 is positioned to direct fuel over a portion of an inner surface of the air foil portion 236 for cooling purposes before the fuel exits the air foil portion 236 through the fuel injection holes 224. For example, the fuel passageway 230 may extend axially through the vane 222 to a surface of the air foil portion 236, where the fuel passageway 230 may branch and travel along an inner surface of the air foil portion 236 toward the fuel injection holes 224, which are positioned on opposite sides of the air foil portion 236. However, other configurations are possible.

With reference back to FIG. 2, the pre-mixing primary fuel-nozzle assembly 210 is mounted to the combustor 200 extending into the first chamber 202. In particular, the pre-mixing primary fuel-nozzle assembly 210 is mounted to the end cover 208 encircling the secondary fuel-nozzle assembly 212. On its rearward side, the pre-mixing primary fuel-nozzle assembly 210 is supported by the end cover 208, and on its forward side, the pre-mixing primary fuel-nozzle assembly 210 comes in close proximity to the combustion liner 206. For example, an outer annular periphery of the pre-mixing primary fuel-nozzle assembly 210 may concentrically align with the combustion liner 206 as shown. In some cases, a leaf spring may be positioned between the combustion liner 206 and a forward outer annular edge of the pre-mixing primary fuel-nozzle assembly 210 to further support the assembly 210 and enclose any space. Thus, the pre-mixing primary fuel-nozzle assembly 210 may fill substantially the entire annular gap 218 between the end cover 208 and the combustion liner 206.

When so positioned, fuel travels axially through the end cover 208 into the assembly 210 and air travels radially through the annular gap 218 into the assembly 210. The assembly 210 swirls the air and injects fuel into the swirling air stream. Such a configuration and flow path differs from known “swozzle”-type fuel nozzles, which typically receive fuel in a radial direction and air in an axial direction. Further, such a configuration and flow path differs from known swozzle-type fuel nozzles in that substantially all of the air entering the secondary fuel-nozzles assembly 212 travels through the pre-mixing primary fuel-nozzle assembly 210 and is swirled by the vanes 226.

To direct fuel into the pre-mixing primary fuel-nozzle assembly 210, the end cover 208 includes at least two fuel manifolds 238, and each fuel manifold 238 is in fluid communication with at least one vane 222. Thus, each vane 222 can receive fuel into its fuel passageway from at least one of the fuel manifolds 238. At some point upstream of the end cover 208, each fuel manifold 238 is also associated with a valve assembly 240, which is operable to permit or prevent the flow of fuel into the fuel manifold 238, thereby permitting or preventing the flow of fuel into the associated vanes 222. The valve assemblies 240 may be controlled by a controller 242, which is operable to regulate fuel flow into the fuel manifolds 238 by controlling the valve assemblies 240. Such a configuration facilitates varying the amount of fuel that is injected into the swirling air flow through the pre-mixing primary fuel-nozzle assembly 210. For example, a sub-set of the vanes 222 may be fueled when the combustor 200 is in diffusion mode, and all of the vanes 222 when the combustor 200 is in a pre-mixing mode.

In the illustrated embodiment, the end cover 208 includes two distinct fuel manifolds 238A and 238B. Each fuel manifold 238A, 238B is in fluid communication with a distinct sub-set of the vanes 222, and each vane 222 is in fluid communication with exactly one of the fuel manifolds 238A, 238B. In particular, the illustrated fuel-nozzle assembly 210 includes fifteen vanes 222, five of the vanes 222 are fueled by the first fuel manifold 238A, and the other ten vanes 222 are fueled by the second fuel manifold 238B. The vanes 222 that are fueled by the first fuel manifold 238A are evenly spaced about the assembly 210, meaning that every third vane 222 is fueled by the first fuel manifold 238A while the remaining vanes 222 are fueled by the second fuel manifold 238B. Such spacing evenly distributes fuel throughout the air-fuel mixture.

Continuing with the illustrated embodiment, the first fuel manifold 238A is associated with a first valve assembly 240A, and the second fuel manifold 238B is associated with a second valve assembly 240B. The valve assemblies 240A, 240B can be controlled, such as via the controller 242, to control the flow of fuel into the vanes 222. For example, fuel can be directed into the first fuel manifold 238A to fuel the five interspaced vanes 222 but not the remaining ten vanes 222. Fuel also can be directed into both fuel manifolds 238A, 238B to fuel all fifteen vanes 222.

A range of other configurations are also envisioned within the scope of the present disclosure. For example, any number of vanes 222 may be positioned about the fuel-nozzle assembly 210, the end cover 208 may have any number of fuel manifolds 238, and the fuel manifolds 238 may communicate fuel into any number or combination of the vanes 222. For example, in one embodiment the first fuel manifold 238A is in fluid communication with a sub-set of the vanes 222 and the second fuel manifold 238B is in fluid communication with all of the vanes 222. Thus, the sub-set of vanes 222 can be fueled by directing fuel into the first fuel manifold 238A and all of the vanes 222 can be fueled by directing fuel into the second fuel manifold 238B. With such a configuration, however, those vanes 222 that are in communication with both fuel manifolds 238 may experience cross-talk between the fuel manifolds 238, wherein fuel from one fuel manifold travels rearward into the other fuel manifold instead of exiting the fuel injection holes 224 into the swirling air flow. Such cross-talk between the fuel manifolds 238 can be eliminated by fueling each vane 222 with only one fuel manifold 238 as described above.

In operation, air from the compressor is driven by a pressure differential along the annular passageway 216 and into the annular gap 218. Substantially all of the air traveling through the annular gap 218 is directed into the pre-mixing primary fuel-nozzle assembly 210. In embodiments in which the combustion liner 206 is substantially continuous about the first chamber 202, substantially all of the head end air passes through the pre-mixing primary fuel-nozzle assembly 210.

The air travels radially inward between the vanes 222, which swirl the air flow, and fuel is injected through the fuel injection holes 224 into the swirling air flow, creating an air-fuel mixture. A portion of the air-fuel mixture turns and travels axially through the assembly 210 into the first chamber 202, while another portion of the air travels radially through the openings 226, turns, and travels axially through the secondary fuel-nozzle assembly 212 into the second chamber 204. Such a configuration differs from the combustor 100, wherein any one of the primary fuel nozzles 110 interacts with only a portion of the air in the first chamber 202 and none of the air in the second chamber 204. Such a configuration also differs from the combustor 100 because all of the primary zone air, and potentially all of the head-end air, is pre-mixed in the pre-mixing primary fuel-nozzle assembly 210.

Some or all of the vanes 222 may be fueled depending on the operating mode. For example, fuel may be provided to only one of the fuel manifolds 238 to fuel a distinct sub-set of the vanes 222, or fuel may be provided to both of the fuel manifolds 238A, 238B to fuel all of the vanes 222. In the illustrated embodiment, five of the vanes 222 may be fueled in one mode while all fifteen vanes 222 may be fueled in another mode. The flow of fuel into the vanes 222 is controlled by the controller 242, which operates the valves assemblies 240A, 240B to permit or prevent the flow of fuel into the fuel manifolds 238 and therefore the vanes 222.

The combustor 200 may be operated in a diffusion mode, wherein combustion occurs in the first chamber 202, and in a pre-mixing mode wherein the first chamber 202 serving as a pre-mixing zone and the second chamber 204 serves as the combustion zone. Like prior combustors, the diffusion mode is used in transition to the pre-mixing mode or in times when a reduced output is desired, while the pre-mixing mode is used during steady-state operation or when increased output is desired. Unlike prior combustors, however, the pre-mixing primary fuel-nozzle assembly 210 performs vane-level pre-mixing in the primary zone during both modes. Substantially all of the primary-zone air, and in some cases substantially all of the air entering the combustor, is pre-mixed at the vane level in the primary zone. The improved vane-level pre-mixing in the primary zone leads to lowers NOx emissions, especially in the pre-mixing mode. (Lower NOx emissions in diffusion mode also may be realized, although the mixing length may be too short due to the proximity of the flame to the pre-mixing primary fuel-nozzle assembly 210). The pre-mixing primary fuel-nozzle assembly 210 imparts swirl or circumferential velocity to the flow, improving flame stability. Thus, the flow is more uniform and yet is stable. Substantially all of all of the primary-zone air, and in some cases substantially all of the air entering the combustor, passes through the pre-mixing primary fuel-nozzle assembly 210 and therefore substantially all of the air is swirled. The increased swirl enables the swirl to propagate farther downstream than with conventional systems that swirl only a portion of the air, improving flame stability. Thereby, less fuel may be burned and emissions may be improved.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

At least the following is claimed:

1. A combustor, comprising:
a first combustion chamber;
a pre-mixing primary fuel-nozzle assembly associated with the first combustion chamber, the pre-mixing primary fuel-nozzle assembly comprising a plurality of vanes configured to swirl airflow, each vane comprising a plurality of fuel injection holes configured to inject fuel into the airflow;
a second combustion chamber; and
a secondary fuel-nozzle assembly associated with the second combustion chamber.

2. The combustor of claim 1, further comprising:
a first fuel manifold that fuels a first sub-set of the vanes; and
a second fuel manifold that fuels a second sub-set of the vanes.

3. The combustor of claim 2, further comprising:
a first valve assembly operable to permit or prevent fuel from flowing into the first fuel manifold;
a second valve assembly operable to permit or prevent fuel from flowing into the second fuel manifold; and
a controller operable to open and close the valves such that fuel flows into the first fuel manifold when the combustor is in a diffusion mode and fuel flows into both the first and the second fuel manifolds when the combustor is in a pre-mixing mode.

4. The combustor of claim 1, wherein the pre-mixing primary fuel-nozzle assembly is concentrically positioned about the secondary fuel-nozzle assembly.

5. The combustor of claim 5, wherein the pre-mixing primary fuel-nozzle assembly is positioned in the first combustion chamber such that air flows through the pre-mixing primary fuel-nozzle assembly in a radially direction and fuel flows through the pre-mixing primary fuel-nozzle assembly in an axially direction.

6. The combustor of claim 1, wherein the pre-mixing primary fuel-nozzle assembly is positioned in the first combustion chamber such that air flows through the pre-mixing primary fuel-nozzle assembly in a radially direction and fuel flows through the pre-mixing primary fuel-nozzle assembly in an axially direction.

7. The combustor of claim 1, further comprising a combustion liner that defines the boundary of the first and second combustion chambers, wherein the combustion liner is substantially continuous about the first combustion chamber such that substantially all air traveling about the combustion liner is directed into the pre-mixing primary fuel-nozzle assembly.

8. A pre-mixing primary fuel-nozzle assembly, comprising:
an inner annular collar comprising a plurality of air passage openings;
a plurality of vanes extending radially outward from the inner annular collar; and
a plurality of fuel injection holes formed in each vane.

9. The pre-mixing primary fuel-nozzle assembly of claim 8, wherein the assembly is open about an outer annular periphery such that air can flow radially inward between the vanes.

10. The pre-mixing primary fuel-nozzle assembly of claim 8, wherein:
the vanes are circumferentially spaced apart from each other about the inner collar;
the air passage openings are interleaved with the vanes;
the pre-mixing primary fuel-nozzle assembly is open about an outer annular periphery such that air flowing radially inward can pass between the vanes and through the openings.

11. The pre-mixing primary fuel-nozzle assembly of claim 8, wherein each vane includes:
a fuel passage portion;
an air foil portion; and
a fuel passageway extending through the fuel passage portion and the air foil portion, the fuel passageway positioned to direct fuel over a portion of an inner surface of the vane to cool the vane, the fuel passageway terminating at the fuel injection holes formed through the air foil portion.

12. A combustor, comprising:
a first combustion chamber associated with a pre-mixing primary fuel-nozzle assembly; and
a second combustion chamber associated with a secondary fuel-nozzle assembly;
wherein the pre-mixing primary fuel-nozzle assembly is concentrically positioned about the secondary fuel-nozzle assembly.

13. The combustor of claim 12, wherein the pre-mixing primary fuel-nozzle assembly is positioned in the first combustion chamber such that air flows through the pre-mixing primary fuel-nozzle assembly in a radially direction and fuel flows through the pre-mixing primary fuel-nozzle assembly in an axially direction.

14. The combustor of claim 12, wherein the pre-mixing primary fuel-nozzle assembly includes:
an inner annular collar;
a plurality of openings formed through the inner annular collar; and
a plurality of vanes extending radially outward from the inner annular collar, the plurality of openings and the plurality of vanes being circumferentially interleaved about the primary fuel-nozzle assembly such that air can pass radially inward between the vanes and through the openings into the secondary fuel-nozzle assembly.

15. The combustor of claim 14, wherein the plurality of vanes are configured to swirl airflow, each vane comprising a plurality of fuel injection holes configured to inject fuel into the airflow.

16. The combustor of claim 12, further comprising:
an end cover that encloses the combustor;
a combustion liner that defines the combustion chambers, the combustion liner spaced apart from the end cover to form an annular gap; and
a flow sleeve positioned about the combustion liner, the flow sleeve spaced apart from the combustion liner to form an annular passageway, the annular passageway in fluid communication with the annular gap;
wherein the pre-mixing primary fuel-nozzle assembly is positioned in the annular gap such that air from the annular passageway is directed through the annular gap into the pre-mixing primary fuel-nozzle assembly.

17. The combustor of claim 16, wherein the combustion liner is substantially continuous about the first combustion chamber such that substantially all of the air in the annular passageway about the first combustion chamber passes through the pre-mixing primary fuel-nozzle assembly.

18. The combustor of claim 16, wherein the primary fuel-nozzle assembly includes:
an inner annular collar;
a plurality of openings formed through the inner annular collar; and
a plurality of vanes extending radially outward from the inner annular collar, the plurality of openings and the plurality of vanes being circumferentially interleaved about the primary fuel-nozzle assembly such that air can pass radially inward between the vanes and through the openings into the secondary fuel-nozzle assembly.

19. The combustor of claim 18, further comprising:
a first fuel manifold formed in the end cover; the first fuel manifold providing fuel a first sub-set of the vanes; and
a second fuel manifold in the end cover, the second fuel manifold providing fuel to a second sub-set of the vanes.

20. The combustor of claim 19, further comprising:
a first valve assembly operable to permit or prevent fuel from flowing into the first fuel manifold;
a second valve assembly operable to permit or prevent fuel from flowing into the second fuel manifold; and
a controller operable to open and close the valves such that fuel flows into the first fuel manifold when the combustor is in a diffusion mode and fuel flows into both the first and the second fuel manifolds when the combustor is in a pre-mixing mode.
